(19) United States
(12) Patent Application Publication
(10) Pub. No.: US 2023/0032269 A1
(43) Pub. Date: Feb. 2, 2023

(54) Method and Unit for Extracting a Component From a Gas Mixture and Method for Transporting a Gas, In Particular Hydrogen or Ammonium

(71) Applicant: HyET Holding B.V., Amhem (NL)

(72) Inventors: Jonne Konink, Arnhem (NL); Rombout Adriaan Swanborn, Arnhem (NL); Albert Bos, Arnhem (NL)

(21) Appl. No.: 17/910,463

(22) PCT Filed: Mar. 9, 2021
(86) PCT No.: PCT/NL2021/050159

§ 371 Date: Sep. 9, 2022

(30) Foreign Application Priority Data
Mar. 9, 2020 (NL) 2025085
Jun. 25, 2020 (NL) 2025919

(51) Int. Cl. B01D 53/32; B01D 53/22; C25B 11/02; C25B 9/67; C25B 9/23; C25B 1/02; C01B 3/50

(52) U.S. Cl. CPC B01D 53/326; B01D 53/228; C01B 3/50; C25B 1/02; C25B 9/23; C25B 9/67; C25B 11/02

(57) ABSTRACT

The present invention relates to an extraction unit for extracting hydrogen from a gas mixture, including a tube or vessel, including a transit channel for passing a gas mixture in a feed-through direction from a receiving opening to a dispensing opening, which tube or vessel is arranged to be received in-line in a gas transport pipe, at least one membrane-electrode assembly arranged in the tube or vessel with at least one anode, a membrane and a cathode. The assembly is arranged such that an anode surface faces the transit channel and that a cathode surface faces away from the transit channel to a drain separated from the feed-through channel. The anode and the cathode are provided with a connector for an electrical voltage source.

### CROSS-REFERENCE TO RELATED APPLICATIONS

This application is the U.S. National Phase of International Application No. PCT/NL2021/050159 filed Mar. 9, 2021, and claims priority to The Netherlands Patent Application Nos. 2025085 filed Mar. 9, 2020 and 2025919 filed Jun. 25, 2020, the disclosures of which are hereby incorporated by reference in their entirety.

### BACKGROUND OF THE INVENTION

### Field of the Invention

The present invention relates to a method and unit for extracting a component from a gas mixture and method for transporting a gas, in particular hydrogen or ammonium.

### Description of Related Art

Hydrogen enjoys a growing popularity as a source of energy, which makes it increasingly important to be able to transport it. At present, fine-meshed hydrogen distribution networks are rare, and hydrogen is distributed with trucks, that can transport 200 to 400 kilograms each time, which may correspond to half a days need at a hydrogen filling station for vehicles. Although it is not inconceivable to build new distribution networks for hydrogen, it is more advantageous when existing (gas) distribution networks are used for the transport of hydrogen. This can be done while still using the gas distribution network for its original purpose, which is: distribution of the existing gas. The hydrogen is then injected at a certain point in the network. One challenge that is faced then is to regain the hydrogen from the gas mixture that is thus created, at least to such level that end users can still use their equipment without obtaining difficulties or disturbances. This does not only apply for hydrogen, but for all gasses that can be selectively transported through a membrane, for instance also ammonium.

### SUMMARY OF THE INVENTION

It is one goal of the present invention to provide an extraction device for extracting a component, in particular hydrogen from a gas mixture. It is a further goal of the present invention to provide a method for transporting a gas.

According to the present invention, an amount of 1% up to 60% in volume of component, in particular hydrogen may be added to the gas in a natural gas network. The component is injected to the distribution system at a certain point in the network and extracted at a point where it is required. It has appeared, that in case of hydrogen, when less than 20%, and preferably less than 10% of the hydrogen remains after extracting the hydrogen from the gas mixture, the equipment of end users (mostly being heating and cooking apparatus) still work fine.

For this purpose, the invention proposes an extraction unit to be placed at or near the position where the component, in particular hydrogen is required, comprising a tube or vessel, comprising a transit channel for passing a gas mixture in a feed-through direction from a receiving opening to a dispensing opening, which tube or vessel is arranged to be received in-line in a gas transport pipe; at least one membrane-electrode assembly (MEA) arranged in the tube or vessel with at least one anode, a membrane and a cathode, the assembly being arranged such that an anode surface faces the transit channel and that a cathode surface faces away from the transit channel to a drain separated from the feed-through channel, and wherein the anode and the cathode are provided with a connector for an electrical voltage source.

Because the membrane only allows protons to pass through, it allows to selectively extract the component from a mixed gas. The proton exchange membrane of the membrane-electrode assembly may be dimensioned such that only the specific component is extracted from the gas mixture.

The actual percentage of the component that is extracted from the gas mixture is dependent on several parameters, such as the length and area of the anode, and the speed at which the gas mixture flows along the anode surface. It has shown that a hydrogen reduction up to a remaining 1% is feasible with the present invention.

Extraction almost always involves gas mixtures with low hydrogen contents (5% - 50%). According to the present invention, preferably between 5% and 25%, and more preferably between 8% and 15% of the component may be added. This components content decreases further while the gas mixture flows past the MEA because the component is removed while the rest of the gas mixture remains. To achieve a sufficiently high recovery (% extracted hydrogen), a substantial decrease in the hydrogen concentration is inevitable. For a recovery of, for example, 60%, the initial hydrogen concentration in the bulk must decrease from (example) 10% to 4%.

The extraction-unit according to the invention may also be applied to purify a syngas, for instance obtained by gasification of coal or biomass and water or to extract hydrogen from a helium / hydrogen mixture. In the latter case, hydrogen may be seen as an impurification of helium that is obtained from a natural source.

Yet another application of the extraction unit according to the invention is to extract hydrogen from a nitrogen / hydrogen mixture. In this case it concerns the cracking of liquid ammonia in N₂ and H₂. The ammonia is then used as a means of transport. Ammonia is obtained (preferably from renewables) and shipped to a location where hydrogen is needed. The liquid ammonia is catalytically cracked to a gas and then the hydrogen is purified from the resulting nitrogen/hydrogen gas mixture.

A further application may be extraction of hydrogen from a stream made by SMR-like (steam methane reforming) processes from fossil raw materials (natural gas, light diesels, etc.).

In general, the extraction unit according to the invention offers the advantage of in-line applicability, a low pressure drop and high capacity, and economic feasibility. By decoupling the extraction from the compression, a cheap extraction unit with a large anode surface suffices in combination with a single compressor unit that compresses the pure component, for instance hydrogen. Instead of 3 to 5 electrochemical compressor stacks that are required according to the state of the art, that extract the component and compress it to 40-900 bar in one step, the extraction unit according to the invention enables to compress with a single compressor stack in addition to the extraction unit.

A further advantage is that no hydraulic sealing system, like in a compressor, is required, because the extraction unit according to the invention is in-line, more in particular in a pipeline, and can operate almost without pressure differential. This also gives more freedom in the choice of materials. Unlike a solid state compressor, the extraction unit according to the invention does not require high-pressure steel. This drastically reduces the costs of the units, even when more m² of membrane/MEA surface are required. When operating without low partial pressure differential, little extra energy is needed to overcome the Nernst voltage, which is the case with a compressor.

Yet another advantage is that relatively much gas flows past the membranes, which allows to passively cool it with this gas flow. As a result, no water cooling circuit is needed in the cells, which further simplifies the design and reduces costs.

In order to increase the devices efficiency, the anode surface may extend non-rectilinearly between the receiving opening and the discharge opening in order to increase a contact length and thereby a contact surface for passing gas. Suitable configurations are for instance one wherein the anode surface is meandering, or wherein the anode surface in a zig-zag saw orientation. Such forms have a large actual length compared to the length of the tube or vessel and thus allow the gas mixture to contact the anode and therewith the extraction of the hydrogen. Additionally, a better distribution of the current over the full membrane is thus obtained, and thus a better heat and water management and a lower energy use are obtained.

For creating space for a relatively large anode surface, there may be a widening in the cross section of the tube or vessel between the receiving opening and the anode surface. In order to allow the extraction unit to be incorporated in a standard gas distribution network, there may also be a taper in the cross section of the tube or vessel between the anode surface and the discharge opening.

There may also be at least one baffle extending with a direction component perpendicular to the feed direction, located in the feed channel, for forcing the gas mixture to move along the anode. The extraction unit may further comprise a compressor for the component such as the compressor connected to the discharge channel, in particular a solid state compressor, and may further be provided with an electrical voltage source connected to the anode and the cathode.

The cathode may preferably comprise a channel structure for a cooling liquid. During a first type of use of the extraction unit according to the invention, the channel structure may be used to circulate a cooling liquid, such as H₂O.

The invention also relates to a method for extracting a component, such as hydrogen from a gas mixture, comprising passing the gas mixture through an extraction unit as described above, applying an electric voltage between the anode and cathode by means of an electric voltage source and passing the component extracted from the gas mixture through the discharge channel.

The component, such as hydrogen may be inserted to a gas or gas mixture, and the method may further comprise transporting the gas or gas mixture with the hydrogen through a gas transport pipe, passing the gas or gas mixture through an extraction unit with the hydrogen and withdrawing the hydrogen from the gas or gas mixture.

The average superficial current density across the membrane may be below 1.0 A/cm² and more particularly below 0.5 A/cm².

The invention also relates to a method as described above, comprising supplying a component, such as oxygen, at the cathode side, for moistening the membrane and thus increasing the efficiency or cleaning the catalyst from contaminants, and thus increasing the efficiency of the apparatus.

### BRIEF DESCRIPTION OF THE DRAWINGS

The invention will now be elucidated into more detail with reference to the following figures, wherein:

FIG. 1 shows a sectional view of an extraction unit according to the invention;

FIG. 2 shows a schematic view of an extraction unit according to the invention; and

FIG. 3 shows further configuration details to a first type of use of the extraction unit according to the present invention.

### DESCRIPTION OF THE INVENTION

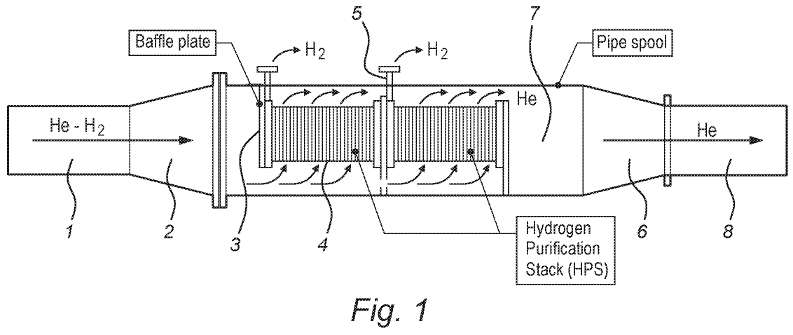

FIG. 1 shows a sectional view of an extraction unit according to the invention, comprising a tube or vessel, comprising a transit channel 6 for passing a gas mixture in a feed-through direction from a receiving opening 1 to a dispensing opening 8, which tube or vessel is arranged to be received in-line in a gas transport pipe, at least one membrane-electrode assembly 4 arranged in the tube or vessel with at least one anode, a membrane and a cathode, the assembly being arranged such that an anode surface faces the transit channel and that a cathode surface faces away from the transit channel to a drain 5 separated from the feed-through channel, and wherein the anode and the cathode are provided with a connector for an electrical voltage source. The anode surface extends non-rectilinearly between the receiving opening and the discharge opening in order to increase a contact length and thereby a contact surface for passing gas. The anode surface is in a meandering orientation.

There is a widening 2 in the cross section of the tube or vessel between the receiving opening and the anode surface and there is a taper 7 in the cross section of the tube or vessel between the anode surface and the discharge opening. Furthermore, there is a baffle 3 extending with a direction component perpendicular to the feed direction, located in the feed channel.

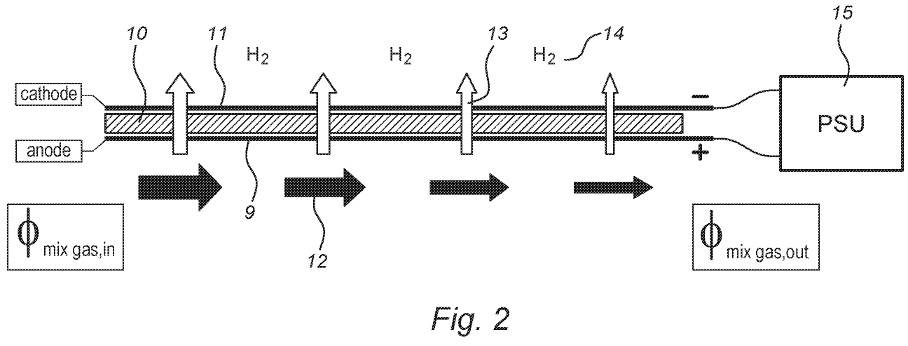

FIG. 2 shows a schematic view of the working principle of an extraction unit according to the present invention. The view shows a transit channel 12 for passing a gas mixture, a membrane-electrode assembly comprising an anode 9, a membrane 10 and a cathode 11 and a drain 14 separated from the feed-through channel, and wherein the anode and the cathode are provided with a connector for an electrical voltage source 15. The hydrogen 13 is extracted from the transit channel 12.

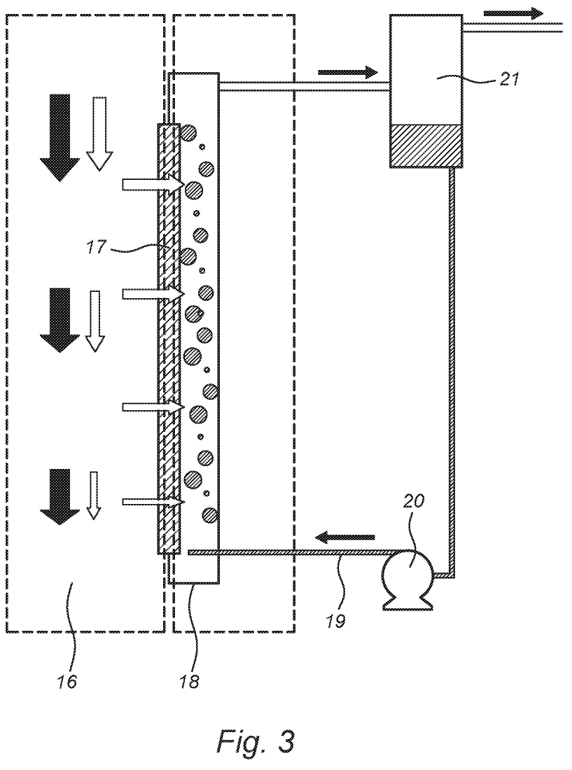

FIG. 3 shows further configuration details of the configuration in FIG. 2, which corresponds to the first type of use of the extraction unit according to the present invention. In this example, a component, such as hydrogen, is added to a gas or gas mixture, which mixture is transported through a pipe or vessel 16, comprising an anode. The membrane 17 is configured for selectively letting the component, in this example hydrogen, pass when a voltage is applied across the cathode and the anode. The cathode 18 is provided with a channel structure, to which water 19 is provided as a cooling liquid by a pump 20, and from which said cooling liquid is drained again. The component, hydrogen as an example, is extracted from the gas mixture and dried by a dryer 21. The component may in a further processing step be compressed to a higher pressure, for instance for filling a vehicle tank.

The invention may also be described according to the following Clauses.

1. Extraction unit for extracting a component, such as hydrogen or ammonium from a gas mixture, comprising:
a tube or vessel, comprising a transit channel for passing a gas mixture in a feed-through direction from a receiving opening to a dispensing opening, which tube or vessel is arranged to be received in-line in a gas transport pipe;
at least one membrane-electrode assembly arranged in the tube or vessel with at least one anode, a membrane and a cathode, the assembly being arranged such that an anode surface faces the transit channel and that a cathode surface faces away from the transit channel to a drain separated from the feed-through channel, and wherein the anode and the cathode are provided with electrical connectors.

2. Extraction unit according to clause 1, wherein the electrical connectors are for connection to a power source and wherein the anode surface extends non-rectilinearly between the receiving opening and the discharge opening in order to increase a contact length and thereby a contact surface for passing gas, in particular wherein the anode surface is in a meandering, or wherein in a zigzag saw orientation of the anode surface has been established.

3. Extraction unit according to clause 1 or 2, wherein there is a widening in the cross section of the tube or vessel between the receiving opening and the anode surface.

4. Extraction unit according to one of the preceding clauses, in which there is a taper in the cross section of the tube or vessel between the anode surface and the discharge opening.

5. Extraction unit according to any one of the preceding clauses, wherein at least one baffle extending with a direction component perpendicular to the feed direction is located in the feed channel.

6. Extraction unit according to one of the preceding clauses, comprising a compressor for the component, such as hydrogen or ammonium connected to the discharge channel, in particular a solid state compressor.

7. Extraction unit according to one of the preceding clauses, comprising an electrical voltage source connected to the anode and the cathode.

8. Extraction unit according to any of the preceding clauses, wherein the cathode comprises a channel structure for a cooling liquid.

9. Extraction unit according to any of the preceding clauses, wherein the cathode comprises a channel structure for moistening the membrane.

10. Method for extracting hydrogen from a gas mixture, comprising passing the gas mixture through an extraction unit according to any one of the preceding clauses, applying an electric voltage between the anode and cathode by means of an electric voltage source and passing the component, such as hydrogen or ammonium extracted from the gas mixture through the discharge channel.

11. Method according to clause 10, wherein the gas mixture is a mixture comprising helium and hydrogen, derived from mining helium from a natural source.

12. Method according to clause 10, wherein the gas mixture is derived from ammonia, split into nitrogen and hydrogen.

13. Method according to clause 10, wherein the gas mixture is a mixture of H₂, CO₂ and CO, in particular a mixture formed by a steam methane reforming process from fossil raw materials such as natural gas and/or light diesels.

14. Method for transporting component, such as hydrogen or ammonium, comprising supplying the component to a gas or gas mixture, transporting the gas or gas mixture with the component through a gas transport pipe, passing the gas or gas mixture with the component through an extraction unit according to any of clauses 1-8 and withdrawing the component from the gas or gas mixture according to the method according to clause 9.

15. Method according to clause 14, wherein the volume percentage is between 5 and 25%, and in particular between 8 and 15%.

16. Method according to any of clauses 10-15, wherein the current density across the membrane is below 0.5 A/cm² and more particularly below 0.3 A/cm².

17. Method according to any of clauses 10-16, comprising supplying a component, such as oxygen, at the cathode side, for moistening the membrane, or cleaning the catalyst from contaminants and thus increasing the efficiency of the apparatus.

1. An extractionunit for extracting a component, such as hydrogen or ammonium from a gas mixture, comprising:
a tube or vessel, comprising a transit channel for passing a gas mixture in a feed-through direction from a receiving opening to a dispensing opening, which tube or vessel is arranged to be received in-line in a gas transport pipe;
at least one membrane-electrode assembly arranged in the tube or vessel with at least one anode, a membrane and a cathode, the assembly being arranged such that an anode surface faces the transit channel and that a cathode surface faces away from the transit channel to a drain separated from the feed-through channel, and wherein the anode and the cathode are provided with electrical connectors.

2. The extraction unit according to claim 1, wherein the electrical connectors are for connection to a power source and wherein the anode surface extends non-rectilinearly between the receiving opening and the discharge opening in order to increase a contact length and thereby a contact surface for passing gas, in particular wherein the anode surface is in a meandering, or wherein in a zigzag saw orientation of the anode surface has been established.

3. The extraction unit according to claim 1 , wherein there is a widening in the cross section of the tube or vessel between the receiving opening and the anode surface.

4. The extraction unit according to claim 1, in which there is a taper in the cross section of the tube or vessel between the anode surface and the discharge opening.

5. The extractionunit according to claim 1, wherein at least one baffle extending with a direction component perpendicular to the feed direction is located in the feed channel.

6. The extraction unit according to claim 1, comprising a compressor for the component, such as hydrogen or ammonium connected to the discharge channel, in particular a solid state compressor.

7. The extraction unit according to claim 1, comprising an electrical voltage source connected to the anode and the cathode.

8. The extraction unit according to claim 1, wherein the cathode comprises a channel structure for a cooling liquid.

9. The extraction unit according to claim 1, wherein the cathode comprises a channel structure for moistening the membrane.

10. A method for extracting hydrogen from a gas mixture, comprising passing the gas mixture through an extraction unit according to claim 1, applying an electric voltage between the anode and cathode by means of an electric voltage source and passing the component, such as hydrogen or ammonium extracted from the gas mixture through the discharge channel.

11. The method according to claim 10, wherein the gas mixture is a mixture comprising helium and hydrogen, derived from mining helium from a natural source.

12. The method according to claim 10, wherein the gas mixture is derived from ammonia, split into nitrogen and hydrogen.

13. The method according to claim 10, wherein the gas mixture is a mixture of H₂, CO₂ and CO, in particular a mixture formed by a steam methane reforming process from fossil raw materials such as natural gas and/or light diesels.

14. A method for transporting a component, such as hydrogen or ammonium, comprising supplying the component to a gas or gas mixture, transporting the gas or gas mixture with the component through a gas transport pipe, passing the gas or gas mixture with the component through an extraction unit and withdrawing the component from the gas or gas mixture .

15. The method according to claim 14, wherein the volume percentage is between 5 and 25%, and in particular between 8 and 15%.

16. The method according to claim 10, wherein the current density across the membrane is below 0.5 A/cm² and more particularly below 0.3 A/cm².

17. The method according to claim 10, comprising supplying a component, such as oxygen, at the cathode side, for moistening the membrane, or cleaning the catalyst from contaminants and thus increasing the efficiency of the apparatus.
